(19) United States
(12) Patent Application Publication
(10) Pub. No.: US 2016/0242148 A1
(43) Pub. Date: Aug. 18, 2016

(54) MULTI-MODE WIRELESS INTERCOM

(71) Applicant: Mark L. REED, Salt Lake City, UT (US)

(72) Inventor: Mark L. REED, Salt Lake City, UT (US)

(21) Appl. No.: 15/043,340

(22) Filed: Feb. 12, 2016

Related U.S. Application Data
(60) Provisional application No. 62/115,973, filed on Feb. 13, 2015.

(51) Int. Cl. H04W 72/04; H04L 12/721; H04L 29/06

(52) U.S. Cl. CPC H04W 72/04; H04L 69/16; H04L 45/66; H04W 84/12

(57) ABSTRACT

Technology for a wireless intercom system is disclosed. A system comprises an intercom device comprising a digital processor, one or more speakers and one or more microphones. The digital processor is configured to receive audio from the one or more microphones and convert the audio to audio data. A communication module operating at the intercom device is configured to communicate the audio data to a remote server via an intercom wireless local area network (WLAN). A routing module, operating at the remote server, is configured to route the audio data communicated from the intercom device to one or more multi-radio access technology (m-RAT) devices via one or more of an m-RAT WLAN or an m-RAT wireless wide area network (WWAN).

### RELATED APPLICATION

This application claims the benefit of a U.S. Provisional application filed on Feb. 13, 2015 in the U.S. Patent and Trademark Office and assigned Ser. No. 62/115,973, the entire disclosure of which is hereby incorporated by reference.

### BACKGROUND

Intercom systems were popular in previous decades before mobile telephone use became ubiquitous. Intercom systems have been used to transmit voice, music, and other audio to be transmitted to one or more rooms having intercom devices. Intercom systems are typically used within a localized area, such as a house or office. The ability to communicate to multiple rooms at once within a location can provide advantages over the one to one communication typical with telephony.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 is a block diagram of a multi-mode wireless intercom system in accordance with an example;

FIG. 2a is a block diagram of a wireless intercom system in accordance with an example;

FIG. 2b is a block diagram of a wireless intercom device in accordance with an example;

FIG. 3 is an example illustration of a wireless intercom device, a base intercom device, or a secondary intercom device in accordance with an example;

FIGS. 4a and 4b are example illustrations of a base intercom device or a secondary intercom device;

FIG. 5 is a flowchart depicting functionality for routing audio data from a wireless intercom device in accordance with an example;

FIG. 6 depicts a flowchart of a method for sending audio data to a wireless intercom in accordance with an example; and

FIG. 7 is a flowchart depicting functionality for routing audio data to an intercom in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Intercom systems have been used in past decades to allow communication to one or multiple locations within a defined region, such as a house or office building. The ability to communicate to multiple locations using voice or audio can provide significant advantages by reducing the time and effort needed to communicate with multiple people and/or locations separately.

The advent of mobile phones has reduced the use of intercom systems. However, most mobile phone systems are not configured to quickly and easily communicate with multiple persons or locations.

While intercom systems are useful within a defined area, such as the house or office, the lack of ability to communicate outside of the defined area using the intercom system can reduce the effectiveness of the intercom system. For example, if a family member wanted to communicate information to the rest of the family, while dad was at the office, mom was at the grocery store, and siblings were located throughout the house, communication would typically entail using an intercom system to communicate throughout the house, and calling mom and dad separately.

In accordance with one embodiment of the present invention, a wireless intercom system and device are disclosed that enables the benefits and advantages of an intercom system and mobile telephony to be combined. The intercom system can enable a user to communicate from an intercom device to other intercom devices, as well as to one or more mobile phones, and vice versa. The ability to use a mobile phone to communicate with an intercom system eliminates the fixed geographic region that the intercom system is located in.

This enables a user to communicate to the multiple locations of an intercom system even when the user is not located within the geographic region in which the intercom system is setup. In addition, users of the intercom system can communicate with people that are not within the geographic region in which the intercom system is setup. This provides significant enhancements to the intercom system, as described in the proceeding paragraphs.

The intercom system also has significant advantages over the use of mobile phones. Mobile phones are typically expensive, multi-functional devices. They are not designed to be left at a specific location nor are they capable of being left on to allow for open communications. Even if a cell phone were left on, the cell phone's battery would quickly drain and the service provider charges could be enormous.

In contrast, an intercom device operating in an intercom system is much less expensive to manufacture and operate. The single purpose design of an intercom system allows each intercom device to be fairly inexpensive. In one embodiment, the intercom device can be connected to a power source, such as a 120 volt connection to a wall socket, allowing the intercom device to be powered on at all times. In addition, the intercom device can be configured to output audio in near real time. While a cell phone can become lost or unanswered, the intercom device's ability to emit audio in near real time allows audio messages to be delivered with a higher probability.

Because the intercom devices are less expensive than cellular telephones, multiple intercom devices can be located in desired locations, such as bedrooms, family rooms, kitchens, offices, and so forth. Intercom systems can be used to monitor multiple locations. Unlike cell phones, which are typically turned on and turned off for specific communications, intercom systems can be used to monitor audio in desired locations for any length of time.

In addition, since the intercom system can be used to deliver near-real-time messages to additional intercom devices and cell phone devices simultaneously, the probability significantly increases that an audio message is delivered and listened to in near-real-time. An intercom system can also be used to provide audio messages to broader audiences. Since the intercom is configured to output the audio to a full room, rather than to a single individual, the intercom system can be used to provide audio messages to a room or a general area, rather than to a specific person. In addition, intercom systems can be used to provide audio messages to multiple locations simultaneously, and allow those multiple locations to communicate. Accordingly, when an audio message needs to be delivered in near real-time, it can be advantageous to use the intercom system instead of a cell phone.

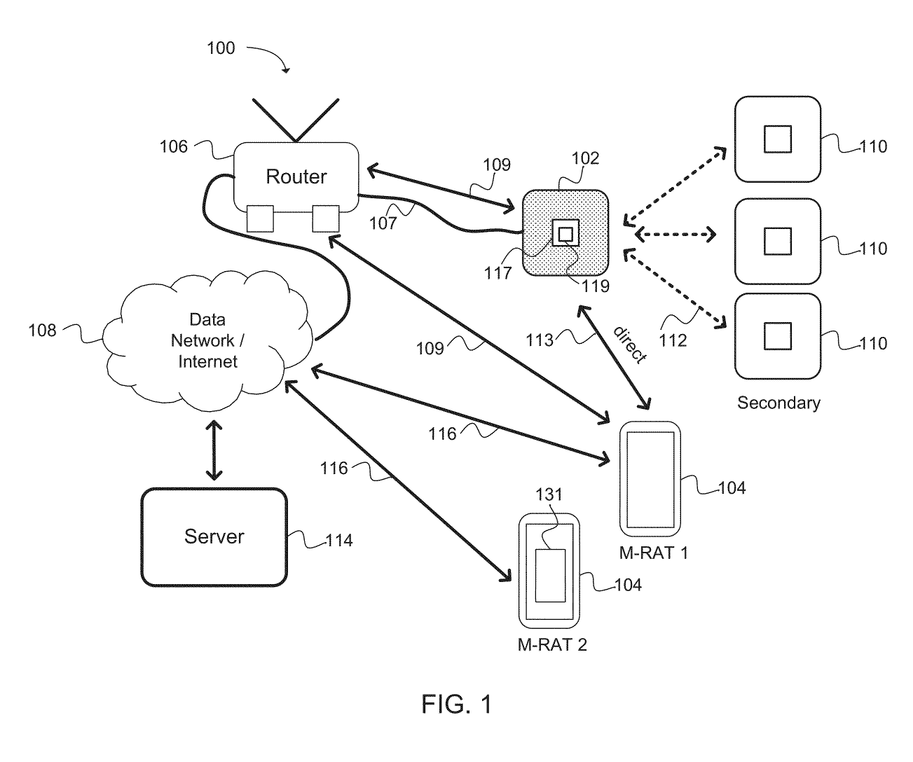

FIG. 1 shows one example of a multi-mode wireless intercom system 100. The multi-mode wireless intercom system can comprise a base intercom device 102. The base intercom device 102 can be configured to communicate with one or more multi-radio access technology (m-RAT) devices 104 via a first wireless local area network (WLAN) 109. In one embodiment, each m-RAT device can be a cellular telephone or other wireless device such as a tablet that is capable of communicating via multiple radio access technologies, including both a WLAN and a wireless wide area network (WWAN). The first WLAN 109 can be configured to operate using a WLAN standard such as an Institute of Electronics and Engineers (IEEE) 802.11a, 802.11b, 802.11g, 802.11n, 802.11ac, 802.11ad, and 802.11ah standard or another desired WLAN standard such as Bluetooth version 1.0, 1.0B, 1.1, 1.2, 2.0, 2.1, or 3.0. The WLAN can include a router 106, such as an IEEE 802.11 access point configured to use one or more of the above standards. The router can be connected to a private data network and/or a public data network such as the Internet 108. In one embodiment, the router 106 can be a wireless router. The base intercom device 102 can be configured to communicate with the wireless router 106. In another embodiment, the router 106 can be connected to the base wireless intercom 102 via a wired Ethernet connection 107. The wired Ethernet connection 107 may be used if interference issues reduce the quality of service of the wireless communication over the first WLAN 109 below a desired threshold level. One or more m-RAT devices 104 can be configured to communicate with the base intercom device 102 via the first WLAN using the router 106.

Alternatively, the one or more m-RAT devices 104 can also be configured to communicate with the base intercom device 102 without the use of the router by communicating with a direct wireless link 113. For example, communication via the direct wireless link 113 can be accomplished using a direct WLAN communication standard, such as WiFi direct, or a third generation partnership project (3GPP) direct communication standard.

The WWAN can be configured to operate using a standard such as a third generation partnership project (3GPP) long term evolution (LTE) Release 8, 9, 10, 11, 12, or 13 standard. In addition, other types of WWAN standards can also be used, such as WIMAX, Universal Terrestrial Radio Access Network (UTRAN), Global System for Mobile Communications (GSM) Enhanced Data rates for GSM Evolution (EDGE) Radio Access Network (GERAN), High-Speed Downlink Packet Access (HSDPA), General Packet Radio Service (GPRS), and so forth.

While most cellular telephones include multiple radio access technologies, the use of the term m-RAT is not intended to fully exclude a cell phone that only operates on a WWAN. In certain embodiments, a cell phone with a single WWAN radio access technology can also be used to communicate with the base intercom device 102 and/or secondary intercom devices 110.

The base intercom device 102 can include one or more speakers that can be configured to play audio communicated from the one or more m-RAT devices 104. The base intercom device 102 can also include one or more microphones that can be used to convert audio to an electronic format that can be transmitted to the one or more m-RAT devices 104. Similarly, each of the one or more secondary intercom devices 110 can include one or more speakers and one or more microphones. In one embodiment, the one or more microphones and one or more speakers can be configured to provide full duplex communication at the base intercom device 102 and/or the secondary intercom devices 110. Alternatively, the one or more microphones and speakers may be configured to provide half duplex communication.

The multi-mode wireless system 100 can also include one or more secondary intercom devices 110 that are configured to communicate with the base intercom device 102 via a second WLAN 112. In one embodiment, the second WLAN 112 may be a different radio access technology (RAT) than is used in the first WLAN 109. For example, the second WLAN 112 can be comprised of an analog connection between the base intercom device 102 and the one or more secondary intercom devices 110. An analog connection can reduce the cost of the secondary wireless intercom devices. Alternatively, the second WLAN may be configured to operate using the same RAT as the first WLAN, such as using an IEEE 802.11 standard or a Bluetooth standard, as previously discussed.

The multi-mode wireless intercom system 100 can further comprise a routing module 117 configured to operate at the base intercom device. The routing module 117 can be configured to route audio data, representing voice or other types of audio, communicated via the second WLAN 112 between the one or more secondary intercom devices 110 and the base intercom device 102 to the one or more m-RAT devices 104 via the first WLAN 109.

In one example, the audio data can be tagged with a destination address and/or an origination address. The audio data may be sent in packets having headers. The destination and/or origination addresses may be included in the header. Alternatively, the destination address and/or origination address can be attached in other formats, as can be appreciated.

In one embodiment, each of the base intercom device 102 and the one or more secondary intercom devices 110 can have a unique address that allows each of the devices to be uniquely identified within the multi-mode wireless intercom system 100. In one example, a media access control (MAC) address can be used to identify each base intercom device 102 and the one or more secondary intercom devices 110. Alternatively, another unique identification means can be used. Each of the one or more m-RAT devices 104 can also have a unique identification, such as a media access control (MAC) address, an International Mobile Equipment Identity (IMEI) address, an integrated circuit card identifier (ICC ID), a Unique Device Identifier (UDID), a secure element ID (SEID), or another desired identification.

Each of the one or more m-RAT devices 104, the base intercom device 102 and the one or more secondary intercom devices 110 can be configured to enable a user to select a desired destination for audio data to be communicated. For example, audio may be selected to be sent from an m-RAT device for playback at the base intercom device 102 or one or more of the secondary intercom devices 110, or a combination of these. In addition, audio may be routed from one secondary intercom device 110 to another secondary intercom device via the base intercom device 102. The base intercom device 102 and the one or more secondary intercom devices 110 can be configured to allow a user to select the desired destination for the audio data using either manual controls, such as switches and/or buttons, or electronically via a graphical user interface. The audio data can then be tagged with the unique ID of the desired destination(s), sent to the base intercom device 102, and properly routed using the routing module 117 operating in the base intercom device 102.

In one embodiment, the base intercom device 102 can include one or more digital memory devices 119. At least one of the one or more digital memory devices can comprise a buffer memory device that can be used to buffer the audio communicated between the base intercom device 102 and the one or more secondary intercom devices 110 via the second WLAN 112.

For example, an analog audio signal may be communicated from a secondary intercom device 110 to the base intercom device 102. The analog audio signal can be converted to digital using an analog to digital (ND) converter and stored in the memory buffer. A digital processor, such as a digital signal processor, can also be used to convert the digitized audio signal to a desired digital format to form audio data. Alternatively, the secondary intercom devices 110 can be configured to receive audio at a microphone, convert the audio to digitized audio data, and send the digitized audio data to the base intercom device 102 to be stored in the buffer memory device. The digital signal processor at the base intercom device may be configured to convert the digitized audio data from the secondary intercom devices into the desired digital format to form the audio data. The audio data can then be sent from the buffer memory device to the one or more m-RAT devices 104 via the first WLAN 109, the WWAN 116, or the direct link 113. Alternatively, the audio data can be used to play back the audio at the base intercom device, at another secondary intercom device, or a combination of devices, as instructed in the destination tag included with the audio data.

Similarly, audio data sent from an m-RAT device 104 to the base intercom device 102 can be stored in a buffer memory device at the base intercom device 102. The audio data sent from an m-RAT device 104 may be stored in the same buffer memory device discussed in the preceding paragraphs. Alternatively, a separate buffer memory device may be used to store audio data sent from the m-RAT device 104 than is used to store audio sent from the secondary intercom device 110. A single digital memory device can be used to store multiple buffer memories. Alternatively, separate digital memory devices can be used to store separate buffer memories. The audio data sent from the m-RAT device 104 that is stored in a buffer memory device can then be routed and sent to one or more of the secondary intercom devices 110 for playback. The audio data may be sent through a digital to audio (D/A) converter and then sent to the secondary intercom devices 110 for playback. Alternatively, the audio data may be played back at the one or more speakers at the base intercom device 102, and/or the one or more secondary intercom devices 110 depending on how the audio data is tagged.

In addition, the secondary intercom devices 110 can also include a buffer memory device 121 to store audio data to be played back at the secondary intercom device, or to be sent to the base intercom device 102 via the second WLAN 112.

Audio data that is transmitted on the first WLAN 109 can be communicated using a desired protocol, such as a transmission control protocol (TCP)/internet protocol (IP), user datagram protocol (UDP), voice over internet protocol (VOIP), or another desired protocol. Audio data transmitted and received on the second WLAN 112 can also be communicated using VOIP or TCP/IP. In another embodiment, analog audio sent over the second WLAN 112 can be sent using amplitude shift keying, phase shift keying, frequency shift keying, or another desired analog modulation scheme. The digital signal processor or other type of processing device in the base intercom device 112 can be configured to format the audio data using the desired protocol.

In one embodiment, audio data that is transmitted on the WWAN 116 can be communicated using VOIP or TCP/IP. Alternatively, the audio data can be communicated over the WWAN 116 to the one or more m-RAT devices 104 using third generation partnership projection (3GPP) internet protocol (IP) multimedia subsystem (IMS) VOIP or another desired protocol. The audio data sent over the data network or internet 108 can also be sent using VOIP, TCP/IP, IMS VOIP, or another desired protocol.

The base intercom device 102 can also be configured to communicate with other base intercom devices. This allows the multi-mode intercom system 100 to be located at multiple locations. Each base intercom device 102 can route audio data to selected secondary intercom devices and/or m-RAT devices.

In one embodiment, an intercom application 231 can be configured to be executed on the one or more m-RAT devices 104. The intercom application 231 can be configured to receive and play the audio data sent from the base intercom device 102 or the one or more secondary intercom devices 110 to one or more selected m-RAT devices 104. The intercom application can also be configured to send audio data from an m-RAT device to the base intercom device 102. Depending on the destination tag included in the audio data, the base intercom device 102 may playback the audio data using the one or more speakers, or may route the audio data to one or more secondary intercom devices 110. If the second WLAN 112 is an analog connection, the audio data may be converted from digital to analog at the base intercom device 102 before it is transmitted to the secondary intercom devices, and vice versa.

The intercom application 131 can also be configured to setup and control the base intercom device 102 and the one or more secondary intercom devices 110. In one example embodiment, a connection can be formed between the m-RAT device 104 and the base intercom device 102 and/or secondary intercom device(s) 110 and data can be communicated using a user datagram protocol (UDP). In one example, network connection information can be communicated to enable the intercom device to establish a connection with the same WiFi network that the m-RAT device is connected to. In addition, each secondary intercom device in the network can be assigned a specific name using the intercom application, such as “office” or “family room”. Groups can also be created. A group can include one or more base intercom devices 102, one or more secondary intercom devices 110, and one or more m-RAT devices 104. When a group communication takes place, such as a page, audio data can be communicated to each device in the group. Each device in the group can also communicate with the device that initiates the communication, as well as all of the other devices in the group.

The intercom application can also be used to adjust permission settings for each device, including the base intercom device 102, secondary intercom device(s) 110, and m-RAT device(s) 104. In one embodiment, each device can be given permission to page, talk, listen, and/or automatically answer or monitor. In some settings, users outside of the immediate family, such as relatives or a baby sitter or nanny, may be given certain permissions such as page, talk, and monitor. However, they may not be given permission to monitor. Alternatively, each device may be set up. Certain devices, such as a device placed near a crib, may be configured to allow monitoring, while devices in other locations, such as an office or a parent's bedroom, may be setup so that monitoring is not allowed.

In one embodiment, the base intercom device 102, and the devices configured to connect with it, such as one or more secondary intercom device(s) 110 and one or more m-RAT device(s) 104 can be a closed group. In order for additional secondary intercom devices or additional M-RAT devices to communicate with the devices in the closed group, the additional devices will need to be configured with, or register with the base intercom device 102. This can provide an additional layer of security for the multi-mode wireless intercom system 100.

In another embodiment, the base intercom device 102 can be configured to communicate with other base intercom devices. For example, a first base intercom device can register with another base intercom device. When a user of the other base intercom device approves the registration, the base intercom device can communicate with the other base intercom device via the router 106 and data network/internet. When the base intercom device is registered, it can enable the secondary intercom devices 110 to communicate with other registered base intercom devices and/or the secondary intercom devices and M-RAT devices associated with the other registered base intercom devices in other closed systems via the base intercom device 110.

The multi-mode wireless intercom system 100 can further comprise a server 114 connected to the private data network or public data network such as the internet 108 and in communication with the base intercom device 102 via the router 106 of the first WLAN 109. The one or more m-RAT devices 104 can also communicate with the server 114 using a wireless wide area network (WWAN) connection to the private data network or public data network such as the internet 108 that allows data to be communicated between the one or more m-RAT devices 104 and the base intercom device 102 via the WWAN 116 using the server 114.

The intercom application operating on the m-RAT device 104 can be configured to communicate audio data over the WWAN to the server, which can then direct the audio data to the base intercom device 102, and/or the one or more secondary intercom devices 110, as directed by a user. In addition, when the m-RAT devices 104 are not connected to the first WLAN, the routing module in the base intercom device 102 can send audio data to the one or more m-RAT devices 104 over the WWAN 116 using the server 114. The server can be configured to communicate audio data from the base intercom device 102 to one or more m-RAT devices 104, as selected by a user, based on the unique identification code of the m-RAT device that is included in the audio data. In one embodiment, the intercom application can be configured to create one or more m-RAT buffer memories to store audio data that is received from the base intercom device 102 and/or audio data that is to be sent to the base intercom device 102. The server 114 typically delivers the audio messages in near real-time. However, it is also possible that the audio messages from the server may be delivered at a later time, or may be stored at the m-RAT device prior to a user listening to the audio message.

When the audio data is sent for playback at any of the one or more m-RAT devices 104, the one or more secondary intercom devices 110, or the base intercom device 102, the audio may be played back on the one or more speakers either automatically in near real-time, or after a user has intervened. For example, in one embodiment, audio data that is received may be automatically played back at the intended device in near real-time without any user interaction. Anyone near the device will hear the audio. In another embodiment, when audio data is received, an indicator, such as a light emitting diode (LED), an emitted audio signal, or a display on a graphical user interface (GUI) can indicate that there is audio to be played back, or that a user would like to send audio (i.e. the audio has not yet been sent, but a user is seeking permission to do so). A response from a user at the playback device, such as pushing a button, can either cause the received audio to be played, or indicate to another user that they can now communicate. Each of the one or more m-RAT devices 104, the one or more secondary intercom devices 110, or the base intercom device 102 can be configured to activate a privacy setting that keeps audio from being sent or delivered. Alternatively, the user sending the audio can format the audio to be automatically played back, or to activate an indicator to a user that they would like to send audio data. The base intercom device 102 and/or secondary intercom devices can also be configured to indicate when they are in privacy mode or automatic playback mode. In one embodiment, the microphones in the base intercom device and secondary intercom device(s) will be turned off when the devices are in privacy mode.

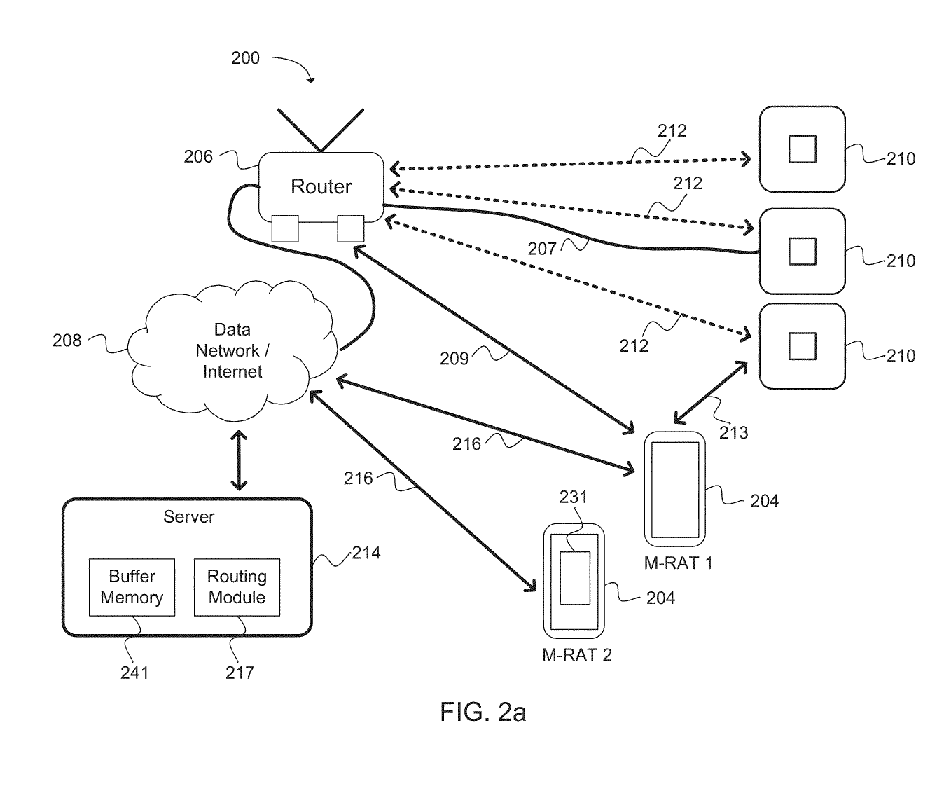

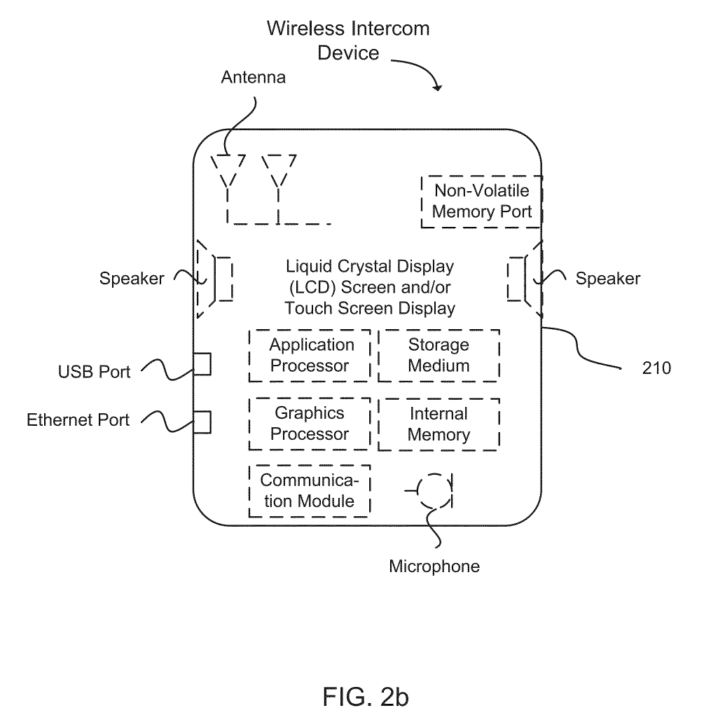

FIG. 2a shows another example of a wireless intercom system 200. In this example, one or more intercom device(s) 210 are configured to communicate directly with a WLAN router 206. The WLAN router can be connected to a server 214 via a data network/internet connection 208.

The WLAN router 206 can be configured to operate using a WLAN standard such as an Institute of Electronics and Engineers (IEEE) 802.11a, 802.11b, 802.11g, 802.11n, 802.11ac, 802.11ad, and 802.11ah standard or another desired WLAN standard such as Bluetooth version 1.0, 1.0B, 1.1, 1.2, 2.0, 2.1, or 3.0. The WLAN router can include a wireless router that includes an IEEE 802.11 access point configured to use one or more of the above standards. The router can be connected to a private data network and/or a public data network such as the Internet 208. In one embodiment, the router 206 can be a wireless router. The intercom device 210 can be configured to communicate with the wireless router 206. In another embodiment, the router 206 can be connected to the wireless intercom 210 via a wired Ethernet connection 207. The wired Ethernet connection 207 may be used if interference issues reduce the quality of service of the wireless communication over the WLAN connection 212 below a desired threshold level. One or more m-RAT devices 204 can be configured to communicate with the intercom device 210 via the WLAN using the router 206 and the server 214.

Alternatively, the one or more m-RAT devices 204 can also be configured to communicate with the intercom device 210 without the use of the router by communicating with a direct wireless link 213. For example, communication via the direct wireless link 213 can be accomplished using a direct WLAN communication standard, such as WiFi direct, or a third generation partnership project (3GPP) direct communication standard.

An M-RAT device 204 can also be configured to communicate with one or more intercom device(s) 210 via a WWAN connection 216 to the server 214. The WWAN can be configured to operate using a standard such as a third generation partnership project (3GPP) long term evolution (LTE) Release 8, 9, 10, 11, 12, or 13 standard. In addition, other types of WWAN standards can also be used, such as WIMAX, Universal Terrestrial Radio Access Network (UTRAN), Global System for Mobile Communications (GSM) Enhanced Data rates for GSM Evolution (EDGE) Radio Access Network (GERAN), High-Speed Downlink Packet Access (HSDPA), General Packet Radio Service (GPRS), and so forth.

The intercom device 210 can include one or more speakers that can be configured to play audio communicated from the one or more m-RAT devices 204. The intercom device 210 can also include one or more microphones that can be used to convert audio to an electronic format that can be transmitted to the one or more m-RAT devices 204. In one embodiment, the one or more microphones and one or more speakers can be configured to provide full duplex communication at the intercom device 204. Alternatively, the one or more microphones and speakers may be configured to provide half duplex communication.

The wireless intercom system 200 can further comprise a routing module 217 configured to operate at the server 214. The routing module 217 can be configured to route audio data, representing voice or other types of audio, between the one or more intercom devices 210 and the one or more m-RAT devices 204. In one embodiment, each m-RAT device 204 can use an intercom application 231 to communicate audio data to the server 214 to be routed to one or more of the intercom devices 210, and receive audio data from the server 214.

In one example, the audio data can be tagged with a destination address and/or an origination address. In one example, the audio data may be sent in packets having headers. The destination and/or origination addresses may be included in the header. Alternatively, the destination address and/or origination address can be attached in other formats, as can be appreciated.

In one embodiment, each of the intercom devices 210 can have a unique address that allows each of the devices to be uniquely identified within the wireless intercom system 200. In one example, a media access control (MAC) address can be used to identify each of the intercom devices 210. Alternatively, another unique identification means can be used. Each of the one or more m-RAT devices 204 can also have a unique identification, such as a media access control (MAC) address, an International Mobile Equipment Identity (IMEI) address, an integrated circuit card identifier (ICC ID), a Unique Device Identifier (UDID), a secure element ID (SEID), or another desired identification.

In one embodiment, the server 214 can operate in the cloud. For example, the server 214 and routing module 217 can be configured to operate using a cloud computing service, such as Amazon Web Services or another desired cloud computing service. Accordingly, the server 214 can be a remote server that is capable of performing the server functions for tens, hundreds, or thousands of different users.

In one embodiment, the server 214 can route the audio to the selected destination(s) in near real-time, thereby enabling a user to communicate using the intercom system, as previously discussed. Alternatively, in selected embodiments, an audio message may be stored for later delivery.

Each of the one or more m-RAT devices 204 and the one or more intercom devices 210 can be configured to enable a user to select a desired destination for audio data to be communicated. For an m-RAT device may be configured to communicate audio data for playback at one or more of the secondary intercom devices 210. In addition, audio may be routed from one intercom device 210 to another intercom device via the server 214. The intercom devices 210 can be configured to allow a user to select the desired destination for the audio data using either manual controls, such as switches and/or buttons, or electronically via a graphical user interface. The audio data can then be tagged with the unique ID of the desired destination(s), sent to the server 214, and properly routed using the routing module 217 operating in the server.

In one embodiment, an intercom group can be setup with one or more wireless intercom devices 210 located at disparate locations. For example, in one intercom group, one or more intercom devices may be located at a user's house and a user's place of business. The location of the house and the business is not relevant, as long as they are both connected to the server using the data network/internet connection 208. A user's house may be located on one continent, and the user's business may be on another continent. In addition, the location of the m-RAT device(s) 204 in an intercom group is not relevant, as long as the m-RAT device(s) 204 can connect to the server 214 via the data network/internet 208 using a WLAN or WWAN connection. Accordingly, an intercom group can be configured at any selected number of locations, as long as the data network/internet connection to the server 214 is available.

FIG. 2b provides a block diagram of an embodiment of a wireless intercom device 210, in accordance with one example. In one embodiment, each intercom device 210 can comprise one or more speakers, a processor and memory. In one embodiment, a separate application processor and graphics processor may be used. Alternatively, a single processor can perform both functions. The memory can comprise internal memory, or another desired form of storage medium. In addition, a non-volatile memory port may be included. The non-volatile memory port can be used to expand memory and transfer information to or from the wireless intercom device 210. At least one of the one or more digital memory devices (i.e. internal memory, storage medium, non-volatile memory port) can comprise a buffer memory device that can be used to buffer the audio communicated between the wireless intercom device 210 and the other wireless intercom devices 210 or m-RAT devices. The application processor, or other desired type of processor, can be configured to perform both analog to digital (A/D) and digital to analog (D/A) conversion of audio. Alternatively, a separate processor, A/D, or D/A may be used.

For example, an analog audio signal may be communicated from the microphone. The analog audio signal can be converted to digital using an analog to digital (A/D) converter and stored in the memory buffer. A digital processor, such as a digital signal processor, can also be used to convert the digitized audio signal to a desired digital format to form audio data. For example, the audio may be converted to a specific type of CODEC. Example codecs include Speex, Opus, and Celt. The codec may be lossy or lossless. The audio data can then be transmitted and received from/to the buffer memory device using the communications module to communicate with other wireless intercom devices and m-RAT devices, as previously discussed.

Returning to FIG. 2a, audio data sent from an m-RAT device 204 to the wireless intercom device 210 can be stored in a buffer memory device at the wireless intercom device 210. The audio data sent from an m-RAT device 210 may be stored in the same buffer memory device discussed in the preceding paragraphs. Alternatively, a separate buffer memory device or storage medium may be used to store audio data sent from the m-RAT device 204 than is used to store audio sent from the wireless intercom device 210. A single digital memory device can be used to store multiple buffer memories. Alternatively, separate digital memory devices can be used to store separate buffer memories. The audio data sent from the m-RAT device 210 that is stored in a buffer memory device can then be sent through a digital to audio (D/A) converter and then sent to the one or more speakers for playback.

Audio data that is transmitted on the WLAN 212 can be communicated using a desired protocol, such as a transmission control protocol (TCP)/internet protocol (IP), user datagram protocol (UDP), voice over internet protocol (VOIP), or another desired protocol. In another embodiment, analog audio sent over the second WLAN 112 can be sent using amplitude shift keying, phase shift keying, frequency shift keying, or another desired analog modulation scheme. The digital signal processor or other type of processing device in the wireless intercom device 210 can be configured to format the audio data using the desired protocol.

In one embodiment, audio data that is transmitted on the WWAN 216 can be communicated using VOIP or TCP/IP. Alternatively, the audio data can be communicated over the WWAN 216 to the one or more m-RAT devices 204 using third generation partnership projection (3GPP) internet protocol (IP) multimedia subsystem (IMS) VOIP or another desired protocol. The audio data sent over the data network or internet 208 can also be sent using VOIP, TCP/IP, IMS VOIP, or another desired protocol.

In one embodiment, an intercom application 231 can be configured to be executed on the one or more m-RAT devices 204, as previously discussed. The intercom application 231 can be configured to receive and play the audio data sent from the wireless intercom device 210. The intercom application 231 can also be configured to send audio data from an m-RAT device 204 to the one or more wireless intercom devices 210. Depending on the destination tag included in the audio data, the audio data can be communicated to one or more selected wireless intercom devices 210.

The intercom application 231 can also be configured to setup and control the wireless intercom device 210. In one example embodiment, a connection can be formed between the m-RAT device 204 and the wireless intercom device 210, and data can be communicated using a selected protocol, such as user datagram protocol (UDP). In one example, network connection information can be communicated to enable the wireless intercom device 210 to establish a connection with the same WiFi network that the m-RAT device is connected to.

In one example, each wireless intercom device 210 in the network can be assigned a specific name using the intercom application 231. For instance, a name such as “office” or “family room” can be assigned. The assigned name can be displayed at the wireless intercom device. Other assigned device names in the network can also be assigned. Groups of assigned device names can also be created. A group can include one or more wireless intercom devices 210 and one or more m-RAT devices 204. When a group communication takes place, such as a page, audio data can be communicated to each device in the group. Each device in the group can also communicate with the device that initiates the communication.

For example, a user can use the intercom application 231 to name a 1^{st} wireless intercom device “family room”, a second wireless intercom device “kitchen”, a 3^{rd} wireless device “mom's phone”, and a 4^{th} wireless device “dad's phone”. A group can then be formed from two or more of the devices. A user can then send a page message from the family room wireless intercom device to the kitchen wireless device, mom's phone, and dad's phone. Audio can be communicated back from each of those devices to the family room wireless intercom device, as well as all of the devices that received the page.

The intercom application 231 can also be used to adjust permission settings for each device. In one example, one or more m-RAT devices 204 operating the intercom application 231 can have rights to set and adjust permission settings. These rights may be protected by password. The rights can be set for each device on the network, including each wireless intercom device(s) 210, and m-RAT device(s) 204. In one embodiment, each device can be given permission to page, talk, monitor, and/or automatically answer. In automatic answer or monitor mode, a user at one device can listen to audio at the location of a second device without user intervention at the second device. A tone may play before the auto answer/monitor mode is initiated to inform people in the room that monitoring is occurring.

In some settings, users outside of the immediate family, business, or group, such as relatives, a baby sitter or nanny, or employees, may be given certain permissions such as page, talk, or monitor. However, in certain situations, users may not be given certain permissions. For example, a user may not be given a permission to monitor or to talk. Alternatively, each wireless intercom device may be set up to have selected permissions. For instance, certain wireless intercom devices, such as a wireless intercom device placed near a crib, may be configured to allow monitoring, while wireless intercom devices in other locations, such as an office or a parent's bedroom, may be setup so that monitoring is not allowed.

When the audio data is sent for playback at any of the one or more m-RAT devices 204 or the one or more wireless intercom devices 210, the audio may be played back on the one or more speakers either automatically, or after a user has intervened. For example, in one embodiment, audio data that is received may be automatically played back at the intended device without any user interaction. Anyone near the device will hear the audio. In another embodiment, when audio data is received, an indicator, such as a light emitting diode (LED), an emitted audio signal, or a display on a graphical user interface (GUI) can indicate that there is audio to be played back, or that a user would like to send audio (i.e. the audio has not yet been sent, but a user is seeking permission to do so). A response from a user at the playback device, such as pushing a button, can either cause the received audio to be played, or indicate to another user that they can now communicate.

In one embodiment, each of the one or more m-RAT devices 204, the one or more wireless intercom devices 210 can be configured to activate a privacy setting that keeps audio from being sent or delivered. Alternatively, the user sending the audio can format the audio to be automatically played back, or to activate an indicator to a user that they would like to send audio data. The wireless intercom device 210 can also be configured to indicate when they are in privacy mode or automatic playback mode. In one embodiment, the microphones in the wireless intercom device(s) will be turned off when the devices are in privacy mode.

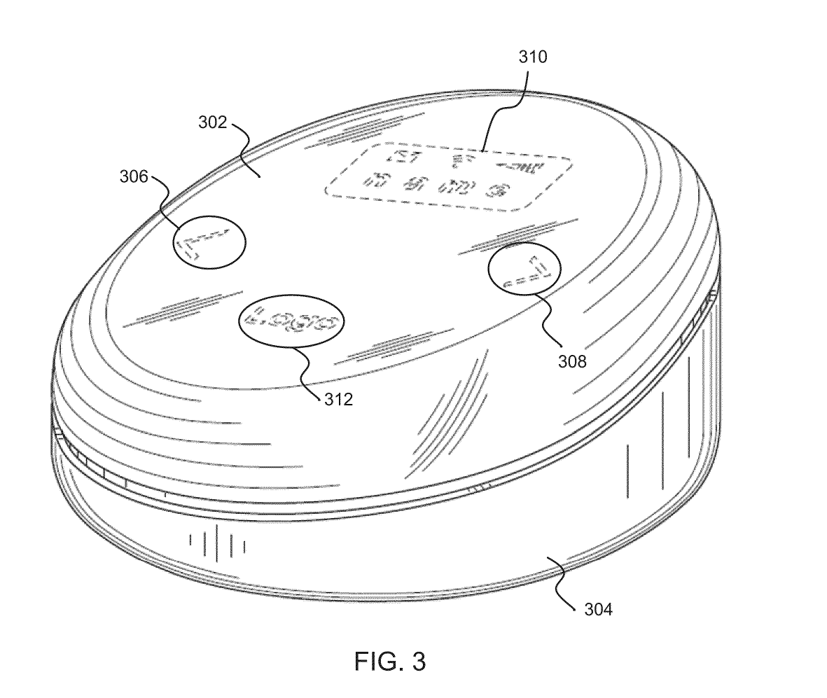

FIG. 3 provides an example illustration of a wireless intercom device 300. The wireless intercom device 300 can be the base intercom device 102 or secondary intercom device 110 of FIG. 1, or the wireless intercom device 210 of FIG. 2. In this example, the wireless intercom device 300 comprises a top section 302 that is operatively connected to a bottom section 304. The top section 302 includes first and second areas 306, 308 that can be depressed to activate a first and a second switch, respectively. The first and second switches can be used to scroll through information displayed in a viewing screen 304. The viewing screen 310 provides a view of a display, such as an LCD display, or other type of display. A third area 312 can be depressed to activate a third switch that can be used to select or activate desired functions of the wireless intercom device 300, as previously described. The wireless intercom device may be powered using batteries or an alternating current (AC) power source.

In one example, a user can use the first and/or second areas 306, 308 to scroll through a contacts list showing available wireless intercom devices and m-RAT devices with which they are configured to communicate. In addition, the user can see groups of available wireless intercom devices with which they can communicate. The third area 312 can be used to select a device or group of devices with which the user wants to communicate. The first and second areas 306, 308 can also be used to adjust the volume of the audio output from the wireless intercom device 300.

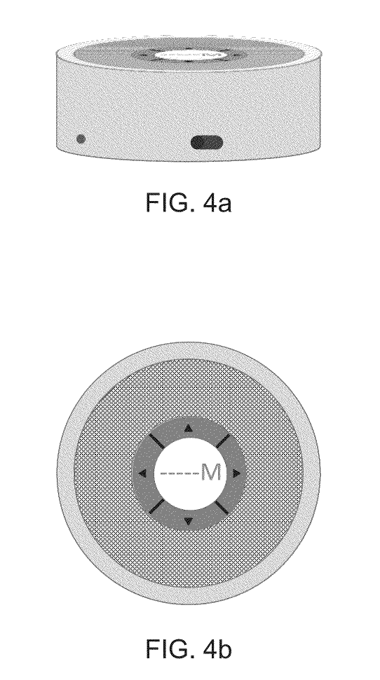

FIGS. 4a and 4b provide example illustrations of another embodiment of a wireless intercom device 210, a base intercom device 102 and/or a secondary intercom device 110. In this example, the intercom device includes speakers and controls used to control the reception and communication of audio signals between the intercom device, and other base intercom devices, secondary intercom devices, and m-RAT devices.

Returning to FIGS. 2a and 2b, a wireless intercom system is disclosed. The wireless intercom system includes an intercom device 210 comprising a digital processor, one or more speakers and one or more microphones, wherein the digital processor is configured to receive audio from the one or more microphones and convert the audio to audio data. The digital processor can include an application processor and/or graphics processor.

The wireless intercom system can further comprise a communication module operating at the intercom device that is configured to communicate the audio data to a remote server 214 via an intercom wireless local area network (WLAN) 212; and a routing module 217 operating at the remote server 214. The routing module can be configured to route the audio data communicated from the intercom device 210 to one or more multi-radio access technology (m-RAT) devices 204 via one or more of an m-RAT WLAN 209 or an m-RAT wireless wide area network (WWAN) 216.

In one embodiment, the wireless intercom system can further comprise an intercom application 231 configured to be executed on each of the one or more m-RAT devices 204, the intercom application configured to receive and play the audio data sent from the remote server 214. The intercom application 231 can be further configured to form an intercom group comprising: two or more intercom devices and one or more m-RAT devices; or two or more m-RAT devices and one or more intercom devices to enable the audio data to be communicated to the group from one of the one or more m-RAT devices or the one or more intercom devices. In one embodiment, each member of the group can communicate with each other member of the group using a paging feature. The routing module 217 can be configured to route the audio data to each member of the group.

The intercom application 231 can be further configured to send audio data from one of the one or more m-RAT devices 204 to the remote server 214 to enable the routing module 217 to route the audio data to one or more intercom devices. The routing module 217 is further configured to route the audio data to one or more additional intercom devices or m-RAT devices 204.

In another embodiment, the intercom device 210 and the one or more m-RAT devices 204 each have a unique identification code that is used to route the audio data: from the intercom device 210 to the one or more m-RAT devices 204; or from the one or more m-RAT devices 204 to one or more intercom devices 210; or from the intercom device to one or more additional intercom devices 210.

The communication module at the intercom device 210 can be configured to packetize the audio data and associate each packet of the audio data with one or more unique identification codes of the one or more m-RAT devices 204 or the one or more additional intercom devices 210 to which the audio data is to be sent.

In another embodiment, an Ethernet connection 207 can be created between the intercom device 210 and a router 206 connected to one or more of a data network or the internet 208. The Ethernet connection 207 can be configured to transmit the audio data between the server 214 and the intercom device 210 on the data network or the internet 208.

In one embodiment, the intercom device 210 can be configured to automatically play the audio data received, from the remote server 214, at the intercom device, on the one or more speakers. The intercom device 210 can also be configured to automatically monitor. Automatic monitoring can comprise the communication of audio that is received at the microphone of a selected intercom device 210 or m-RAT device 204 to one or more intercom device(s) 210 or m-RAT device(s) 204 that is monitoring audio at the selected device.

The intercom device 210 can also include a privacy setting configured to require user interaction with the intercom device 210 (i.e. approval) before audio data can be sent from the intercom device 210 to the server 214 or before audio data received at the intercom device 210 from the remote server 214 is played. In other words, the privacy setting can be used to control automatically playing received audio and monitoring of audio data without user approval.

In another embodiment, the intercom device 210 can be configured to communicate the audio data between the intercom device 210 and the one or more m-RAT devices 204 using a WiFi direct connection 213 between the intercom device 210 and the one or more m-RAT devices 204. In another embodiment, the server 214 can be configured to communicate the audio data from the intercom device 210 to the one or more m-RAT devices 204 via a WiFi router 206. The WiFi router 206 can be configured to operate using one or more of an Institute of Electronics and Engineers (IEEE) 802.11a, 802.11b, 802.11g, 802.11n, 802.11ac, 802.11ad, and 802.11ah standard.

In one embodiment, the intercom device 210 can include a buffer memory device to buffer the audio data communicated between the intercom device 210 and the remote server 214. The buffer memory may be configured at an internal memory, a non-volatile external memory port, or a storage medium. The remote server 214 can further comprise a buffer memory device 241 to buffer the audio data communicated between the intercom device and the remote server. The buffer memory at the remote server can be an internal memory, a non-volatile external memory port, or a storage medium.

In one embodiment, the WLAN 212 is configured to operate using one or more of an Institute of Electronics and Engineers (IEEE) 802.11a, 802.11b, 802.11g, 802.11n, 802.11ac, 802.11ad, or 802.11ah standard, or a Bluetooth Version 1.1, 1.2, 2.0, 2.1, 3.0, 4.0, 4.1 or 4.2 standard.

In an embodiment, the audio data can be communicated between the intercom device 210 and the server 214 using one or more of transmission control protocol (TCP)/internet protocol (IP), user datagram protocol (UDP), or voice over internet protocol (VOIP).

In another embodiment, the audio data can be communicated from the remote server 214 on a data network or the internet 208 to the one or more m-RAT devices 204 using third generation partnership projection (3GPP) internet protocol (IP) multimedia subsystem (IMS) VOIP. The audio data can be communicated on a WWAN connection 216. The WWAN can be configured to operate using a standard such as a third generation partnership project (3GPP) long term evolution (LTE) Release 8, 9, 10, 11, 12, or 13 standard. In addition, other types of WWAN standards can also be used, such as WIMAX, Universal Terrestrial Radio Access Network (UTRAN), Global System for Mobile Communications (GSM) Enhanced Data rates for GSM Evolution (EDGE) Radio Access Network (GERAN), High-Speed Downlink Packet Access (HSDPA), General Packet Radio Service (GPRS)

In another embodiment, a wireless intercom device 210 is disclosed comprising: one or more speakers; one or more microphones; a digital processor configured to receive audio from the one or more microphones and convert the audio to audio data; and a communication module configured to: packetize the audio data for communication to a remote server 214 via an intercom wireless local area network (WLAN) 212; and associate each packet with one or more unique identification numbers, wherein each unique identification number is associated with a multi-radio access technology (m-RAT) device 204 to enable the remote server 214 to route the audio data to one or more m-RAT devices 204 via one or more of an m-RAT WLAN 209 or an m-RAT wireless wide area network (WWAN) 216 using the one or more unique identification numbers.

In one embodiment, the communications module is further configured to receive audio data from another wireless intercom device 210 or the one or more m-RAT devices 204. The digital processor can be further configured to automatically play the received audio data on the one or more speakers of the wireless intercom device 210 when the wireless intercom device has a permission setting to allow the audio data to be automatically played.

In another embodiment, the received audio from the one or more microphones can be automatically communicated to one or more additional intercom devices 210 or one or more m-RAT devices 204 to monitor the received audio when the wireless intercom device has a permission setting to allow the received audio to be monitored.

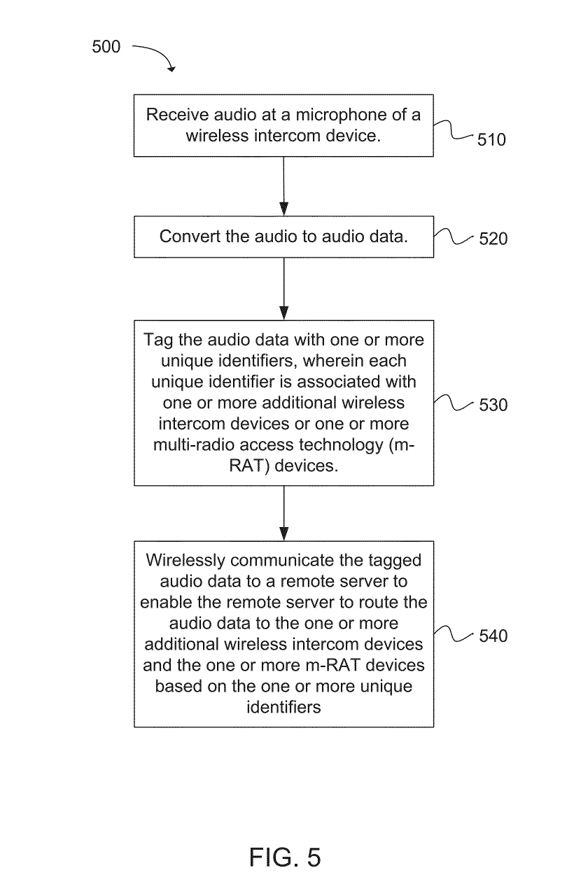

In another embodiment, functionality 500 for routing audio data from a wireless intercom device is disclosed, as shown in the flow chart in FIG. 5. The functionality can be implemented as a method or the functionality can be executed as instructions on a machine, where the instructions are included on at least one computer readable medium or one non-transitory machine readable storage medium. Audio data can be received at a microphone of a wireless intercom device, as shown in block 510. The audio data can be converted to audio data, as shown in block 520. The audio data can be tagged with one or more unique identifiers, wherein each unique identifier is associated with one or more additional wireless intercom devices or one or more multi-radio access technology (m-RAT) devices, as shown in block 530. The tagged audio data can be wirelessly communicated to a remote server to enable the remote server to route the audio data to the one or more additional wireless intercom devices and the one or more m-RAT devices based on the one or more unique identifiers, as shown in block 540.

In one embodiment, audio data can be received at the wireless intercom device from the remote server that is routed from the one or more additional wireless intercom devices and the one or more m-RAT devices to the wireless intercom device based on the one or more unique identifiers. A permission setting of the wireless intercom device to automatically play received audio data without user intervention can be identified. The received audio data can be automatically played on a speaker of the wireless intercom device based on the permission setting.

For example, a user may use an application on an m-RAT device to communicate a message to the wireless intercom device. The message can be communicated from the m-RAT device to the server, and then routed to the wireless intercom device. If the wireless intercom device has a permission setting configured to allow automatic playback, the audio message from the user can be played in near-real time (i.e. the speaker can emit the audio message) at the wireless intercom device without any user interaction. A person near the wireless intercom device can then listen to the message and respond, allowing the user and the person to have a conversation using the wireless intercom device.

Alternatively, if the permission setting does not allow automatic playback, then a tone or indicator can be performed at the wireless intercom device. The person can interact with the wireless intercom device, such as by depressing a button to accept the incoming message, thereby allowing the person to hear the message in near-real time from the user, and to respond. As previously discussed the wireless intercom device can be full duplex, allowing the person and user to communicate interactively, or half duplex, allowing the user and person to take turns communicating.

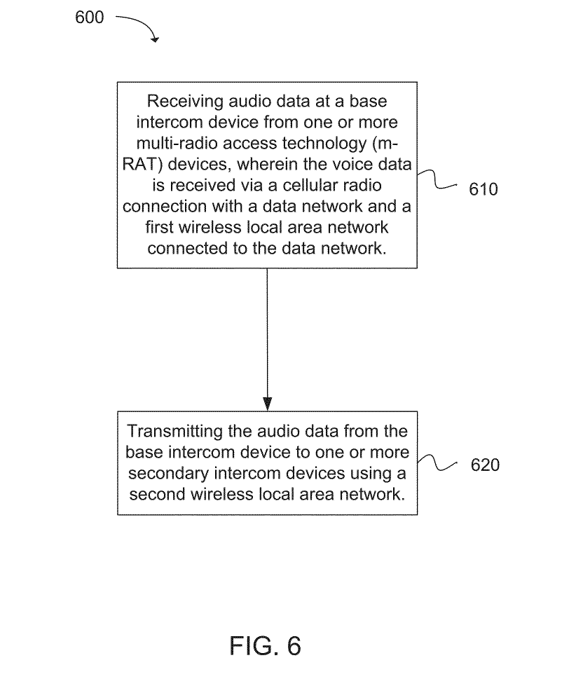

Another example provides a method 600 for sending audio data to a wireless intercom, as shown in the flow chart in FIG. 6. The method can be executed as instructions on a machine, where the instructions are included on at least one computer readable medium or one non-transitory machine readable storage medium. The method can include the operation of receiving audio data at a base intercom device from one or more multi-radio access technology (m-RAT) devices, wherein the audio data is received via a cellular radio connection with a data network and a first wireless local area network connected to the data network, as in block 610. The method can include the operation of transmitting the audio data from the base intercom device to one or more secondary intercom devices using a second wireless local area network, as in block 620.

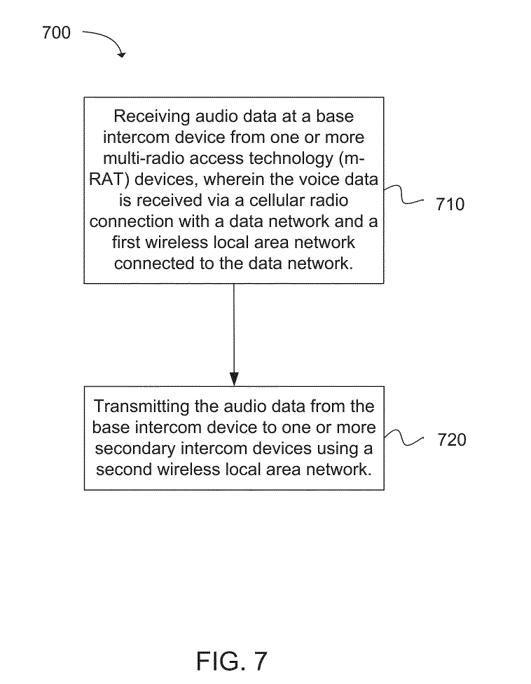

Another example provides functionality 700 for routing audio data to an intercom, as shown in the flow chart in FIG. 7. The functionality can be implemented as a method or the functionality can be executed as instructions on a machine, where the instructions are included on at least one computer readable medium or one non-transitory machine readable storage medium. Audio data can be received at a base intercom device from a multi-radio access technology (m-RAT) device via a wireless data network, as in block 710. The audio data can be routed from the base intercom device to a secondary intercom device via a second wireless data network to enable the secondary intercom to emit audio from the secondary intercom device based on the audio data, as in block 720.

### Example Embodiments

1. A multi-mode wireless intercom system, comprising:
   a base intercom device configured to communicate with one or more multi-radio access technology (m-RAT) devices via a first wireless local area network (WLAN), wherein the base intercom device comprises one or more speakers and one or more microphones;
   one or more secondary intercom devices configured to communicate with the base intercom device via a second WLAN, wherein the one or more secondary intercom devices each comprise one or more speakers and one or more microphones; and
   a routing module operating at the base intercom device, wherein the routing module is configured to route audio data communicated via the second WLAN between the one or more secondary intercom devices and the base intercom device to the one or more m-RAT devices via the first WLAN.
2. The multi-mode wireless intercom system of example 1, further comprising an intercom application configured to be executed on the one or more m-RAT devices, the intercom application configured to receive and play audio data sent from the base intercom device or the one or more secondary intercom devices to a selected m-RAT device.
3. The multi-mode wireless intercom system of example 2, wherein the intercom application is further configured to send audio data to one or more of the base intercom device and the one or more secondary intercom devices.
4. The multi-mode wireless intercom system of example 1, wherein the routing module is further configured to route the audio data between the base intercom device and the one or more m-RAT devices via a wireless wide area network (WWAN).
5. The multi-mode wireless intercom system of example 1, further comprising a server in communication with the base intercom device via one or more of the first WLAN or a data network in communication with the WLAN, wherein the server is configured to send the audio data received from the one or more m-RAT devices via a wireless wide area network to the base intercom device.
6. The multi-mode wireless intercom system of example 1, wherein the base intercom device, the one or more secondary intercom devices, and the one or more m-RAT devices each have a unique identification code that can be used to direct the audio data from the one or more m-RAT devices to one or more of the base intercom device and the one or more secondary intercom devices, or direct the audio data from the base intercom device or the one or more secondary intercom devices to the one or more m-RAT devices.
7. The multi-mode wireless intercom system of example 1, further comprising an Ethernet connection between the base intercom device and a router connected to one or more of a data network or the internet, wherein the Ethernet connection is configured to transmit the audio data between the data network and the base intercom device.
8. The multi-mode wireless intercom system of example 1, wherein one or more of the base intercom device or the one or more secondary intercom devices are configured to automatically play the audio data sent to the base intercom device or the one or more secondary intercom devices on the one or more speakers.
9. The multi-mode wireless intercom system of example 1, wherein the base intercom device or the one or more secondary intercom devices includes a privacy setting configured to require user interaction with the base intercom device or the one or more secondary intercom devices before audio data sent to the base intercom device or the one or more secondary intercom devices is played.
10. The multi-mode wireless intercom system of example 1, wherein the base intercom device is configured to register with one or more additional base intercom devices to enable the base intercom device, the one or more secondary intercom devices, and the one or more m-RAT devices to communicate with the one or more additional base intercom devices, and the one or more secondary intercom devices and one or more m-RAT devices associated with each of the one or more additional base intercom devices.
11. The multi-mode wireless intercom system of example 5, wherein the base station is configured to communicate the audio data between one of the base intercom device or the one or more secondary intercom devices and the one or more m-RAT devices using the server to communicate the audio data via a cellular connection of the m-RAT devices.
12. The multi-mode wireless intercom system of example 1, wherein the base intercom device is further configured to communicate the audio data from one of the base intercom device and the one or more secondary intercom devices directly with the one or more m-RAT devices using a WiFi direct connection.
13. The multi-mode wireless intercom system of example 1, wherein the base intercom device is further configured to communicate the audio data from one of the base intercom device and the one or more secondary intercom devices via a WiFi router.
14. The multi-mode wireless intercom system of example 13, wherein the WiFi router is configured to operate using one or more of an Institute of Electronics and Engineers (IEEE) 802.11a, 802.11b, 802.11g, 802.11n, 802.11ac, 802.11ad, and 802.11ah standard.
15. The multi-mode wireless intercom system of example 1, wherein the base intercom device further comprises a buffer memory device to buffer the audio data communicated between the base intercom device and the one or more secondary intercom devices via the second WLAN.
16. The multi-mode wireless intercom system of example 15, wherein the base intercom device is further configured to communicate the audio data in the buffer memory device between the base intercom device and the one or more m-RAT devices via the first WLAN.
17. The multi-mode wireless intercom system of example 15, wherein the base intercom device is further configured to communicate the audio data in the buffer memory device between the base intercom device and the one or more m-RAT devices via a WiFi direct connection between the base intercom device and the one or more m-RAT devices.
18. The multi-mode wireless intercom system of example 5, wherein the base intercom device is further configured to communicate the audio data in a buffer memory device between the base intercom device and the one or more m-RAT devices via the first WLAN and a wireless wide area network (WWAN) using the server.
19. The multi-mode wireless intercom system of example 1, wherein the first WLAN is configured to operate using one or more of an Institute of Electronics and Engineers (IEEE) 802.11a, 802.11b, 802.11g, 802.11n, 802.11ac, 802.11ad, or 802.11ah standard, and a Bluetooth standard.
20. The multi-mode wireless intercom system of example 19, wherein the audio data is transmitted on the first WLAN using one or more of transmission control protocol (TCP)/internet protocol (IP) or voice over internet protocol (VOIP).
21. The multi-mode wireless intercom system of example 20, wherein the audio data communicated using the TCP/IP or the VOIP is communicated using the TCP/IP or the VOIP between the first WLAN and a server connected to one or more of a data network or the internet.
22. The multi-mode wireless intercom system of example 21, wherein the audio data is communicated from the data network or the internet to the one or more m-RAT devices using third generation partnership projection (3GPP) internet protocol (IP) multimedia subsystem (IMS) VOIP.
23. The multi-mode wireless intercom system of example 1, wherein the second WLAN is configured to operate using one or more of an Institute of Electronics and Engineers (IEEE) 802.11a, 802.11b, 802.11g, 802.11n, 802.11ac, 802.11ad, or 802.11ah standard, and a Bluetooth standard.
24. The multi-mode wireless intercom system of example 23, wherein the audio data is transmitted on the second WLAN using one or more of a transmission control protocol (TCP)/internet protocol (IP) or a voice over internet protocol (VOIP).
25. The multi-mode wireless intercom system of example 1, wherein the base intercom device and the one or more secondary intercom devices are configured to transmit the audio data on the second WLAN using one or more of amplitude shift keying, phase shift keying, and frequency shift keying for reproduction of the audio data as audio at the one or more secondary intercom devices.
26. The multi-mode wireless intercom system of example 1, wherein the one or more speakers and the one or more microphones at the base intercom device are configured to provide full duplex communications at the base intercom device.
27. The multi-mode wireless intercom system of example 1, wherein the one or more speakers and the one or more microphones at the one or more secondary intercom devices are each configured to provide full duplex communications at each of the secondary intercom devices.
28. At least one non-transitory machine readable storage medium having instructions embodied thereon for routing audio data to an intercom, the instructions when executed by at least one processor, perform the following:
   receiving audio data at a base intercom device from a multi-radio access technology (m-RAT) device via a wireless data network; and
   routing the audio data from the base intercom device to a secondary intercom device via a second wireless data network to enable the secondary intercom to emit audio from the secondary intercom device based on the audio data.
29. A method for sending audio data to a wireless intercom, comprising:
   receiving audio data at a base intercom device from one or more multi-radio access technology (m-RAT) devices, wherein the audio data is received via a cellular radio connection with a data network and a first wireless local area network connected to the data network; and
   transmitting the audio data from the base intercom device to one or more secondary intercom devices using a second wireless local area network.

Various techniques, or certain aspects or portions thereof, can take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a RAM, EPROM, flash drive, optical drive, magnetic hard drive, solid state drive, or other medium for storing electronic data. The node and wireless device can also include a transceiver module, a counter module, a processing module, and/or a clock module or timer module. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations.

It should be understood that many of the functional units described in this specification have been labeled as modules, in order to more particularly emphasize their implementation independence. For example, a module can be implemented as a hardware circuit comprising custom VLSI circuits or gate arrays, off-the-shelf semiconductors such as logic chips, transistors, or other discrete components. A module can also be implemented in programmable hardware devices such as field programmable gate arrays, programmable array logic, programmable logic devices or the like.

In one example, multiple hardware circuits can be used to implement the functional units described in this specification. For example, a first hardware circuit can be used to perform processing operations and a second hardware circuit (e.g., a transceiver) can be used to communicate with other entities. The first hardware circuit and the second hardware circuit can be integrated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network. The modules can be passive or active, including agents operable to perform desired functions.

Reference throughout this specification to “an example” means that a particular feature, structure, or characteristic described in connection with the example is included in at least one embodiment of the present invention. Thus, appearances of the phrases “in an example” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A wireless intercom system, comprising:
an intercom device comprising a digital processor, one or more speakers and one or more microphones, wherein the digital processor is configured to receive audio from the one or more microphones and convert the audio to audio data;
a communication module operating at the intercom device that is configured to communicate the audio data to a remote server via an intercom wireless local area network (WLAN); and
a routing module operating at the remote server, wherein the routing module is configured to route the audio data communicated from the intercom device to one or more multi-radio access technology (m-RAT) devices via one or more of an m-RAT WLAN or an m-RAT wireless wide area network (WWAN).

2. The wireless intercom system of claim 1, further comprising an intercom application configured to be executed on each of the one or more m-RAT devices, the intercom application configured to receive and play the audio data sent from the remote server.

3. The wireless intercom system of claim 2, wherein the intercom application is further configured to form an intercom group comprising:
two or more intercom devices and one or more m-RAT devices; or
two or more m-RAT devices and one or more intercom devices to enable the audio data to be communicated to the group from one of the one or more m-RAT devices or the one or more intercom devices.

4. The wireless intercom system of claim 2, wherein the intercom application is further configured to send audio data from one of the one or more m-RAT devices to the remote server to enable the routing module to route the audio data to one or more intercom devices.

5. The wireless intercom system of claim 1, wherein the routing module is further configured to route the audio data to one or more additional intercom devices.

6. The wireless intercom system of claim 1, wherein the intercom device and the one or more m-RAT devices each have a unique identification code that is used to route the audio data:
from the intercom device to the one or more m-RAT devices; or
from the one or more m-RAT devices to one or more intercom devices; or
from the intercom device to one or more additional intercom devices.

7. The wireless intercom system of claim 6, wherein the communication module at the intercom device is configured to packetize the audio data and associate each packet of the audio data with one or more unique identification codes of the one or more m-RAT devices or the one or more additional intercom devices to which the audio data is to be sent.

8. The wireless intercom system of claim 1, further comprising an Ethernet connection between the intercom device and a router connected to one or more of a data network or the internet, wherein the Ethernet connection is configured to transmit the audio data between the server and the intercom device on the data network or the internet.

9. The wireless intercom system of claim 1, wherein the intercom device is configured to automatically play the audio data received, from the remote server at the intercom device, on the one or more speakers.

10. The wireless intercom system of claim 1, wherein the intercom device includes a privacy setting configured to require user interaction with the intercom device before audio data can be sent from the intercom device to the server or before audio data received at the intercom device from the remote server is played.

11. The wireless intercom system of claim 1, wherein the intercom device is further configured to communicate the audio data between the intercom device and the one or more m-RAT devices using a WiFi direct connection between the intercom device and the one or more m-RAT devices.

12. The wireless intercom system of claim 1, wherein the server is further configured to communicate the audio data from the intercom device to the one or more m-RAT devices via a WiFi router.

13. The wireless intercom system of claim 12, wherein the WiFi router is configured to operate using one or more of an Institute of Electronics and Engineers (IEEE) 802.11a, 802.11b, 802.11g, 802.11n, 802.11ac, 802.11ad, and 802.11ah standard.

14. The wireless intercom system of claim 1, wherein the intercom device further comprises a buffer memory device to buffer the audio data communicated between the intercom device and the remote server.

15. The wireless intercom system of claim 1, wherein the remote server further comprises a buffer memory device to buffer the audio data communicated between the intercom device and the remote server.

16. The wireless intercom system of claim 1, wherein the WLAN is configured to operate using one or more of an Institute of Electronics and Engineers (IEEE) 802.11a, 802.11b, 802.11g, 802.11n, 802.11ac, 802.11ad, or 802.11ah standard, or a Bluetooth Version 1.1, 1.2, 2.0, 2.1, 3.0, 4.0, 4.1 or 4.2 standard.

17. The wireless intercom system of claim 1, wherein the audio data is communicated between the intercom device and the server using one or more of transmission control protocol (TCP)/internet protocol (IP), user datagram protocol (UDP), or voice over internet protocol (VOIP).

18. The wireless intercom system of claim 1, wherein the audio data is communicated from the remote server on a data network or the internet to the one or more m-RAT devices using third generation partnership projection (3GPP) internet protocol (IP) multimedia subsystem (IMS) VOIP.

19. A wireless intercom device, comprising:
one or more speakers;
one or more microphones;
a digital processor configured to receive audio from the one or more microphones and convert the audio to audio data; and
a communication module configured to:
packetize the audio data for communication to a remote server via an intercom wireless local area network (WLAN); and
associate each packet with one or more unique identification numbers, wherein each unique identification number is associated with a multi-radio access technology (m-RAT) device to enable the remote server to route the audio data to one or more m-RAT devices via one or more of an m-RAT WLAN or an m-RAT wireless wide area network (WWAN) using the one or more unique identification numbers.

20. The wireless intercom device or claim 19, wherein the communications module is further configured to receive audio data from another wireless intercom device or the one or more m-RAT devices.

21. The wireless intercom device or claim 20, wherein the digital processor is further configured to automatically play the received audio data on the one or more speakers when the wireless intercom device has a permission setting to allow the audio data to be automatically played.

22. The wireless intercom device or claim 19, wherein the received audio from the one or more microphones is automatically communicated to one or more additional intercom devices or one or more m-RAT devices to monitor the received audio when the wireless intercom device has a permission setting to allow the received audio to be monitored.

23. At least one non-transitory machine readable storage medium having instructions embodied thereon for routing audio data to from a wireless intercom device, the instructions when executed by at least one processor, perform the following:
receive audio at a microphone of a wireless intercom device;
convert the audio to audio data;
tag the audio data with one or more unique identifiers, wherein each unique identifier is associated with one or more additional wireless intercom devices or one or more multi-radio access technology (m-RAT) devices; and
wirelessly communicate the tagged audio data to a remote server to enable the remote server to route the audio data to the one or more additional wireless intercom devices and the one or more m-RAT devices based on the one or more unique identifiers.

24. The at least one non-transitory machine readable storage medium of claim 23, further comprising:
receive audio data at the wireless intercom device from the remote server that is routed from the one or more additional wireless intercom devices and the one or more m-RAT devices based on the one or more unique identifiers;
identify a permission setting of the wireless intercom device to automatically play received audio data without user intervention; and
automatically play the received audio data on a speaker of the wireless intercom device based on the permission setting.
